(19) United States
(12) Patent Application Publication
(10) Pub. No.: US 2008/0121063 A1
(43) Pub. Date: May 29, 2008

(54) Linkage Arrangement and a Vehicle Handlebar Fitment

(76) Inventor: Richard Paul Thrower, Aylsham (GB)

Correspondence Address: BRUCE E. LILLING;LILLING & LILLING PLLC, P.O. BOX 560, GOLDEN BRIDGE, NY, 10526, US

(21) Appl. No.: 11/531,819

(22) Filed: Sep. 14, 2006

(51) Int. Cl. B62K 21/14

(52) U.S. Cl. 74/470

(57) ABSTRACT

A linkage arrangement comprises a first attachment member for fixedly attaching to a support structure such as a vehicle handle bar and a second attachment member for loosely attaching to said support structure; a resilient joining member for joining the first and the second member; and a member for carrying an object such as a vehicle brake lever; whereby when the object is acted against the resilience of the joining member, it displaces from its rest position and thereafter returns under the resilience of the joining member to its rest position.

### BACKGROUND OF THE INVENTION

1. Field of the Invention

The invention relates to linkage arrangements and a vehicle handlebar fitments.

The term ‘vehicle’ is to be interpreted broadly to include mobile person carrying devices such as bicycles, motorcycles, quads, automobiles, snow mobiles, bobsleighs, rail going, airborne and waterborne vehicles.

2. Summary of the Prior Art

As motorcycles and in particular off-road motorcycles are used for example for acrobatic stunts, inclined when going through bends or when the motorcycles impact against the ground for any other reason, the brake lever is often impacted against which may lead to the brake lever being damaged or at worst broken off because of the inherent rigidity of the brake lever.

In the prior art, patterns have been carried out in terms of providing a pivot point at the brake lever. Although the brake lever is to a certain degree protected by such prior art mechanism, such a mechanism requires the modification of the lower extremity of the brake lever as well as requiring the rider to manually replace a pivoted lever for efficient continued use after an impact.

### SUMMARY OF THE INVENTION

In a first broad independent aspect, the invention provides a linkage arrangement comprising a first attachment member for fixedly attaching to a support structure such as a vehicle handle bar and a second attachment member for loosely attaching to said support structure; a resilient joining member for joining said first and second member; and a member for carrying an object such as a vehicle brake lever; whereby when the object is acted against the resilience of said joining member, it displaces from its rest position and thereafter returns under the resilience of said joining member to its rest position.

This combination of features is particular advantageous because it allows repeated deflection of, for example, a brake lever attached in this manner to a handle bar whilst achieving the re-positioning after, for example, an impact has displaced the lever during use. This configuration has the additional benefit as not requiring any modification to the brake lever itself so that it can be used with conventional objects which require no modification.

In a subsidiary aspect in accordance with the invention's broadest independent aspect, the joining member is a plate of resilient material.

This configuration avoids having to use other resilient members such as helical springs which would require more complex positioning and potentially a housing to protect the user from inadvertently touching the spring. In fact, the plate may itself be used and appear to the rider of a motorcycle, for example, to be a decorative element.

In a subsidiary aspect, the joining member incorporates a second plate which is relatively rigid when compared to said resilient plate.

In a further subsidiary aspect, the invention provides a linkage arrangement, wherein the first attachment member and the second attachment member are so sized and shaped to fit around the handle bar of a vehicle.

This marks a complete departure from the prior art teaching of necessarily modifying the lower brake lever. It allows unmodified conventional brake levers to be used. It achieves all the advantages of the above first broad independent aspect. It also allows repeated impacts to be experienced by the brake or gear lever without any damage to these levers occurring or permanent displacements of the levers from their conventional rest position.

In a further subsidiary aspect, the second attachment member and at least the joining member form a single component. In this configuration, no releasable attachment means such as nuts and bolts are required to secure the second attachment member to the joining member. Such a configuration will also render the linkage arrangement more compact than otherwise would be the case to reduce any risk of unnecessary use of the handle bar surrounding area.

In a further subsidiary aspect, the second attachment member forms an unbroken loop extending around the diameter of a handle bar. This optional configuration is advantageous because it simplifies the manner in which the linkage arrangement would be mounted onto the handle bar. It would also reduce the number of releasable attachment means and even possibly do away with the requirement of incorporating any. By contrast, a broken loop would require multiple releasable attachment means to secure matting components one relative to the other.

In a second broad independent aspect, the invention provides a vehicle (such as a motorcycle or the like) handle bar fitment, comprising an attachment member which allows a handle bar lever to be rotated around the vehicle handle bar and which is sufficiently resilient so that when the lever is rotated against the resilience of said attachment member, the fitment displaces from its rest position and thereafter returns under the resilience of said attachment member to its rest position.

This configuration is particularly advantageous because it allows components such as a vehicle brake lever or a vehicle gear lever to be impacted against and thereby deflected without any or only minor damage occurring to these components whilst subsequently allowing the levers to return to their conventional position for continued and uninterrupted riding of the vehicle.

### BRIEF DESCRIPTION OF THE SEVERAL VIEWS OF THE DRAWINGS

FIG. 1 shows a perspective view of a linkage arrangement for use on a motorcycle handle bar for the attachment of a lever.

FIG. 2 shows in perspective view an alternative embodiment of the invention with a linkage arrangement for attachment to a handle bar.

FIG. 3 shows a perspective view of a further linkage arrangement as used on a handle bar.

### DETAILED DESCRIPTION OF THE PREFERRED INVENTION

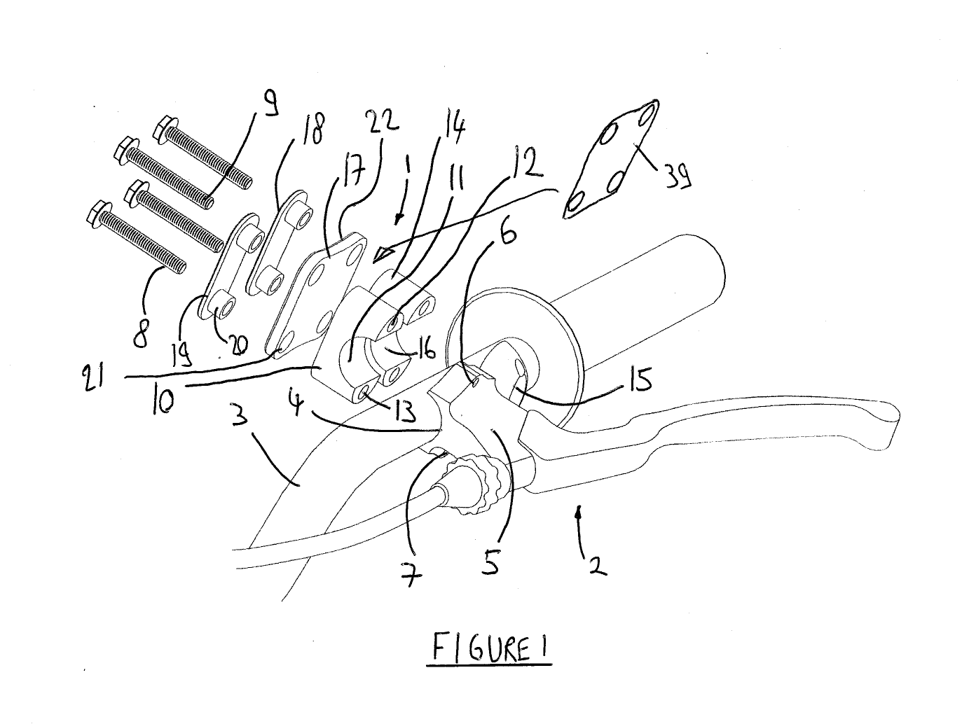

FIG. 1 shows a linkage arrangement 1 for the attachment of a motorcycle lever onto a handle bar 3. Lever 2 incorporates a curved handle bar engaging surface 4 which corresponds to the radius of handle bar 3. The mounting block 5 of the lever incorporates oppositely located threaded upper and lower bores 6 and 7 which respectively receive threaded extremities of bolts 8 and 9. Bridge shaped member 10 incorporates an inner curved surface 11 for engagement with handle bar 3.

When bolts 8 and 9 are inserted through bores 12 and 13 of bridge member 10 and are subsequently threaded into threaded bores 6 and 7, bridge member 10 is secured onto mounting block 5 of the lever 2. By sizing the radius of curved surfaces 11 and 4 respectively in excess of the radius of handle bar 3, even when bores 8 and 9 cause mounting block 5 to be tightly secured against bridge member 10, no secured attachment to handle bar 3 occurs so that the lever may pivot relative to the axis of the handle bar.

In order to prevent the lever from freely rotating around the handle bar, a second bridge member is provided and referenced 14 in the figure. Bridge member 14 is designed to attach to mounting block 15. Bridge member 14 incorporates a radius 16 designed to correspond precisely to the radius of the handle bar 3 so that when bridge member 14 is attached to block member 15 these are fixedly attached to the handle bar so they cannot rotate one relative to the other.

A flexible plate 17 joins bridge member 10 to bridge member 14. The plate may preferably be of rectangular or square shape in order to achieve sufficient rigidity and flexibility so that when lever 2 is impacted against limited rotation may occur and subsequent repositioning of the lever relative to the handle bar occurs. Fixing plates 18 and 19 with projections such as the projection referenced 20 are employed to fit into recesses such as recess 21 in the flexible plate 17. The flexible plate may also be coated by a textile material 22 which may be used for advertising purposes as well as protection of the rubber surface. Whilst the flexible plate may be of conventional rubber, it may also be constituted of a fibre reinforced elastomer.

Optionally, in one preferred embodiment a plate 39 may be added between plate 17 and the bridge members for additional rigidity during normal use of the lever. Plate 39 is therefore preferably of rigid plastics material when compared to plate 17. Plate 39 may be of any suitable material which would not tend to crack during normal use but would under impact. Such a material may for example be a rigid plate of polypropylene or polyethylene.

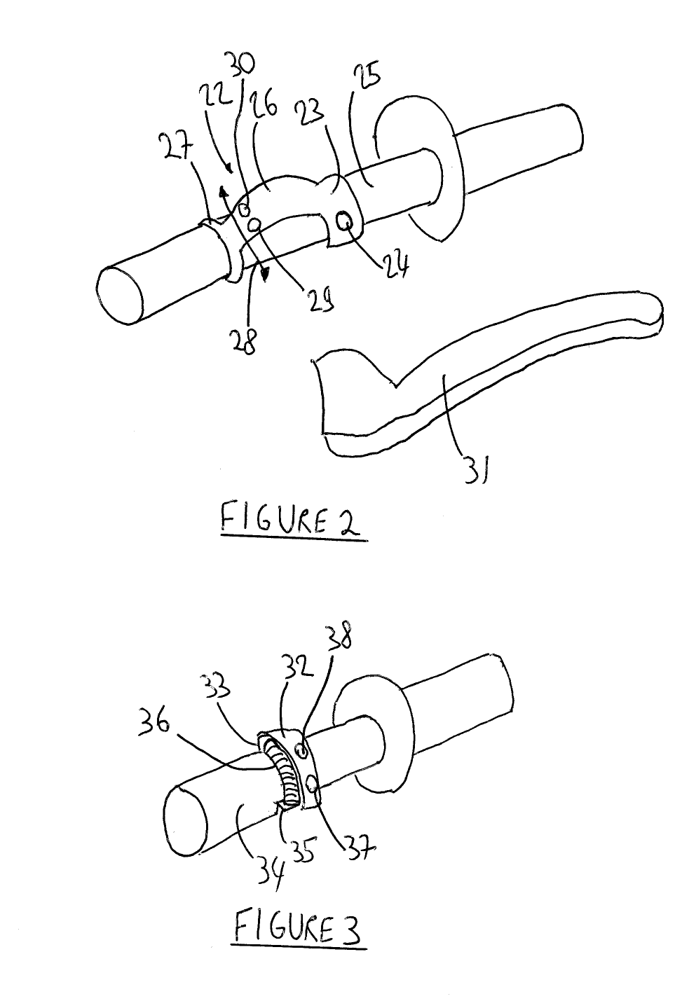

The following two embodiments show structures which are also part of the same broad inventive concepts as embodiment 1. FIG. 2 shows a linkage arrangement 22 with a first attachment member 23 which may be bolted through a bolt 24 or any other suitable attachment means to the handle bar 25 so that attachment member 23 is prevented from rotating relative to the handle bar. From attachment member 23 a bridge 26 is provided which carries out the function of the flexible plate 17 of the previous embodiment. The flexible bridge 26 is hooped onto handle bar 25 via a ring shaped member 27 so that the linkage arrangement may be located onto the handle bar whilst allowing displacement to occur as shown by arrow 28. As part of the bridge 26, threaded bores 29 and 30, are envisaged which would allow the lever 31 to be securely attached to the linkage arrangement 22. In this configuration, lever 31 would be permitted restricted and resilient rotation relative to handle bar 25.

FIG. 3 shows a further embodiment where a bearing-like member 32 is rotatably located onto the handle bar. The bearing 32 incorporates a projection 33 which extends laterally whilst handle bar 34 incorporates a projection 35. A spring 36 is located in abutment against projection 33 and projection 35 whereby constraining the rotation of the bearing 32 about the handle bar 34. The rotation of bearing 34 is permitted only against the resilience of spring 36. Consequently, when a lever (none shown) is attached to the bearing via appropriate attachment means such as threaded bores 37 and 38 and if the lever is impacted, displacement about the handle bar is permitted followed by the return of the lever to its original position due to the resilience of spring 36.

The scope of the invention is defined in the claims that now follow.

1. A linkage arrangement comprising a first attachment member for fixedly attaching to a support structure such as a vehicle handle bar and a second attachment member for loosely attaching to said support structure; a resilient joining member for joining said first and second member; and a member for carrying an object such as a vehicle brake lever; whereby when the object is acted against the resilience of said joining member, it displaces from its rest position and thereafter returns under the resilience of said joining member to its rest position.

2. A linkage arrangement according to claim 1, wherein the joining member is a plate of resilient material.

3. A linkage arrangement according to claim 2, wherein the joining member incorporates a second plate which is relatively rigid when compared to said resilient plate.

3. A linkage arrangement according to claim 1, wherein the first attachment member and the second attachment member are so sized and shaped to fit around the handle bar of a vehicle.

4. A linkage arrangement according to claim 1, wherein the second attachment member and at least the joining member form a single component.

5. A linkage arrangement according to claim 1, wherein the second attachment member forms an un-broken loop extending around the diameter of a handle bar.

6. A vehicle (such as a motorcycle or the like) handle bar fitment, comprising an attachment member which allows a handle bar lever to be rotated around the vehicle handle bar and which is sufficiently resilient so that when the lever is rotated against the resilience of said attachment member, the fitment displaces from its rest position and thereafter returns under the resilience of said attachment member to its rest position.
